(19) United States
(12) Patent Application Publication
(10) Pub. No.: US 2009/0135986 A1
(43) Pub. Date: May 28, 2009

(54) NUCLEAR POWER INSTALLATION AND A METHOD FOR ITS CONSTRUCTION

(76) Inventor: Hans Georgii, London (GB)

Correspondence Address: STITES & HARBISON PLLC, 1199 NORTH FAIRFAX STREET, SUITE 900, ALEXANDRIA, VA, 22314, US

(21) Appl. No.: 11/718,057

(22) PCT Filed: Nov. 24, 2005
(86) PCT No.: PCT/SE05/01763

§ 371 Date: Apr. 26, 2007

(30) Foreign Application Priority Data
Nov. 24, 2004 (SE) 0402863-5

(51) Int. Cl. G21C 3/00

(52) U.S. Cl. 376/272; 376/409

(57) ABSTRACT

In a nuclear power installation a nuclear reactor (R) and other parts or components which are hazardous because of radioactivity or other hazard factors are placed in a lower part (12) of the installation which is located at a level deep below the ground level, whereas a ground-level part (11) of the installation comprises equipment for making the energy produced by the reactor useful. The deep-level part (12) of the installation includes a storage site (19) for spent nuclear fuel (29). These two pans (11, 12) of the installation are interconnected by a passageway which is suitably formed by one or more shafts.

The present invention relates to an underground nuclear power installation and a method for the construction of such an installation.

With few exceptions, the existing nuclear power installations are located at or very close to the ground level, in the open air. A very small number of installations of research or experimental nature are located in rock caves which have a roof with a thickness of some ten or twenty metres and are accessed through a short passage between the cave and the open air (Agesta, Sweden, and Halden, Norway).

Construction of new nuclear power installations occurs only relatively infrequently. The explanation for this would seem to be found primarily in the widespread public opposition to nuclear power. Most probably, this opposition to a great extent is based on factual and subjectively felt dangers associated with the existence and operation of nuclear power installations and with the management and storage of spent nuclear fuel.

The problem to be solved by the invention is to provide a nuclear power installation which meets stringent demands on the safety against undesired environmental effects, especially uncontrolled release of radioactive materials into the environment from the installation or from storages of spent nuclear fuel and to provide a method for the construction of such a nuclear power installation.

The solution provided by the invention is based on the concept of locating the parts of the installation which are regarded as particularly hazardous at a deep-level location in the ground (in the bedrock) and locate other, less hazardous parts at or near the ground level.

Parts of the installation which can be regarded as particularly hazardous in the context of the invention and are therefore to be located at a deep-level site in the ground are chiefly the nuclear reactor and other components and materials which are extremely hazardous because of their radioactivity or other factors and which have therefore to be controlled or handled and stored in a safe manner, so that radioactive materials or other hazardous materials are prevented, both in a short view and in a long view, from spreading in an uncontrolled manner beyond the immediate vicinity of the installation.

Parts of the installation which can be regarded as less hazardous in the context of the invention and do not therefore require a particularly protected deep-level location in the ground are, for example, equipment for controlling and monitoring the installation, equipment for making the thermal energy produced in the reactor useful and other components of the installation for which adequate safety can be provided without such a protected location. In the context of the invention, making the energy produced in the reactor useful means extracting the energy liberated in the reactor and bringing it into a form such that it can be transmitted and utilized.

In accordance with the invention, parts of the installation which may cause an uncontrolled release of hazardous materials in the event of a failure occurring in the installation are therefore located at such a depth and so connected to other parts of the installation that any uncontrolled release of hazardous materials can very reliably be kept off from places where they can do serious harm. The deep-level location of parts of the installation which are hazardous in the above-mentioned sense applies not only to the sector which accommodates the reactor, but also to parts of the installation where spent nuclear fuel is handled and stored.

Parts of the installation which are “safe” are preferably located at or near the ground level where personnel required for the operation of the installation can normally stay. In this description “at or near the ground level” or “ground-level” imply that these safe parts may be located entirely or to a greater or smaller extent below the ground level at such a depth that they are protected against attacks from outside but yet considerably closer to the ground level than the hazardous parts, so that there is a great, from a safety point of view adequate distance down to the parts of the installation which have a deep-level location.

Within the scope of the invention, it is possible to place at least some of the “safe” parts relatively close to, but still at a safe distance from the hazardous parts. This preferably applies to parts whose location near the reactor facilitates the energy transmission from the reactor or reduces the energy losses associated with the transmission.

In accordance with the invention, the minimum depth for locating the reactor and other parts of the installation which are hazardous in respect of uncontrolled release of hazardous materials, is chosen taking into account the character of the bedrock at the site of the installation, and in some measure also the geographical location of the installation. Among the factors that should be taken into consideration when selecting the depth is the stability and homogeneity of the bedrock, not only at the very site of the installation, but also in the surrounding area, and the distance from population centres. In no case, however, even in the most favourable conditions, should the depth be less that 50 metres, measured from the ground level down to the ceiling of the cave accommodating the reactor, and a preferred minimum depth is 100 metres. Desirably, the depth is at least 300 metres, and a preferred depth range is 300 to 1000 metres.

Spent nuclear fuel is placed in caves which are preferably located lower than the deep-level location of the rest of the installation, preferably in drilled shafts. These shafts may be positioned side by side, separated by suitable distances and extend down to depths of several thousand metres, and they may excavated in numbers that are high enough to provide for accommodation of all the spent nuclear fuel that is expected to be produced during the life of the installation.

In view of the development of the deep drilling technology that has taken place, it is technologically and economically realistic to place nuclear reactors and other hazardous parts of a nuclear power installation at the afore-mentioned deep levels. It is now possible to drill holes of a depth substantially greater than one thousand metres and wide enough make it possible to lower through them a reactor tank and other large parts of a nuclear reactor of an ordinary size.

A feature of the nuclear power installation according to the invention thus is that its reactor and other parts or components which are hazardous because of the radioactivity or other hazard factors, are located at a level deep below the ground level, whereas a ground-level part, that is, a part of the installation which is located at or near the ground level, comprises equipment for making the thermal energy produced in the reactor and transferred to the reactor coolant useful.

The ground-level part of the installation and the deep-level part of the installation are interconnected through a passageway formed by one or more shafts in an intermediate-level part of the installation which is formed chiefly by the ground or bedrock.

Making the energy useful normally comprises conversion of the energy into electric energy by means of steam turbines, generators and ancillary auxiliary equipment and means for the transmission of energy between the deep-level and ground-level parts on the installation. Naturally, making the energy useful may also take place partly close to the reactor and partly close to the ground level.

A feature of the nuclear power installation according to the invention is also that the disposal of the spent nuclear fuel, that is, its transfer from the reactor to what for practical purposes may be its ultimate disposal, takes place near the reactor, that is, without the spent fuel being moved up to the ground surface or to near the ground level.

The above-mentioned features of the nuclear power installation according to the invention are appealing as a solution to the safety problems which, for reasons which may be more or less well-founded, are attributed to the existing nuclear power installations. It is easy to understand that the location of the reactor section and other “hazardous” parts of the installation deep below the ground level and the possibility to carry out the disposal of spent nuclear fuel near the reactor section, and thus likewise deep below the ground level, offers such a high degree of safety that the risk of the nuclear fuel causing serious environmental consequences is minimal.

Application of the invention is not limited to any particular type or size of nuclear power installation or nuclear power reactor, but at the present point in time the invention, in view of its general nature, namely the location of the reactor and other parts which are hazardous because of the radioactivity, is believed to be particularly well suited for small to medium-sized installations.

An example of the type of nuclear power installation which appears particularly interesting for the application of the invention is the type of installation that has a so-called “pebble bed” reactor, also known as a “ball bed” reactor. In this description, the designation PB reactor is used below for this type of reactor. PB reactors have existed for several decades but have not been widely used. Recently, however, PB reactors have gained increased interest, and this type of reactor is believed to have a good chance of becoming more widely used than till now.

A few among the many existing examples of patent documents which describe PB reactors are US 2003/0112919 A1, US2003/0194043 A1, US 2004/0066875 A1, US 2004/146135 A1, and U.S. Pat. No. 5,051,230.

A feature that distinguishes PB reactors from the reactor types which are common today is the shape of the nuclear fuel and the fuel management within and outside the reactor.

In boiling water reactors, for example, the fuel is in the shape of long, slender fuel rods which are assembled in bundles within elongate housings and together with these form so-called fuel assemblies. When a boiling water reactor is loaded, a large number of fuel assemblies are inserted into the reactor core, in which during operation of the reactor a water coolant flows through the fuel assemblies to carry the energy produced as a result of the nuclear reaction from the reactor to equipment that converts the energy into a suitable form. When the nuclear fuel eventually has become spent, the fuel assemblies are removed and replaced with new fuel assemblies containing fresh nuclear fuel. The refuelling takes a considerable time, several weeks, and during the time it is carried out, the reactor has to be shut down so that it does not produce any energy. Management and storage of the spent nuclear fuel requires extremely great efforts because of the safety requirements.

In contrast to the intermittent fuel management with very long times elapsing between the refuellings, a more or less continuous supply of the nuclear fuel into the reactors and discharge of the fuel from the reactor characterises one type of PB reactor. The fuel is in the shape of spheres of approximately the size of a tennis ball and contain the fissionable fuel together with graphite and are clad with a silicon carbide shell. During operation of the reactor, a great number of such spheres, such as 100 to 200 per day, are continually passed, possibly together with graphite spheres, into the reactor, and spheres are discharged from the reactor at the same rate, so that the reactor always contains almost the same number of spheres. Before they have become spent, the balls have passed through the reactor several times. Thus, the reactor can always operate at a substantially constant reactivity and with an advantageous distribution of the power density throughout the reactor.

In a known PB reactor type (U.S. Pat. No. 5,051,230) the same type of fuel is used, but the loading with fresh fuel and discharge of spent fuel does not take place continuously as in the type of reactor described above. The most prominent difference is that the loading of the fuel first takes place in batch fashion until the reactor has been loaded to a certain degree, to one-third of full load, for example, and then continuously until the reactor is fully loaded, and that the fuel is discharged only when all the fuel in the reactor is spent, and then all of the fuel is discharged in batch fashion.

Normally, a PB reactor has no reactor containment of the kind existing in the nuclear power installations which are common today. The absence of such a safety containment has been held out as a serious safety problem with PB reactors. In the nuclear power installation according to the invention a separate reactor containment can be dispensed with, because the ground or bedrock around the deep-level part of the installation serves as a natural safety containment.

The basic principles of the invention and important or at least advantageous features are illustrated in the annexed diagrammatic drawings and are described in greater detail below with reference to the drawings.

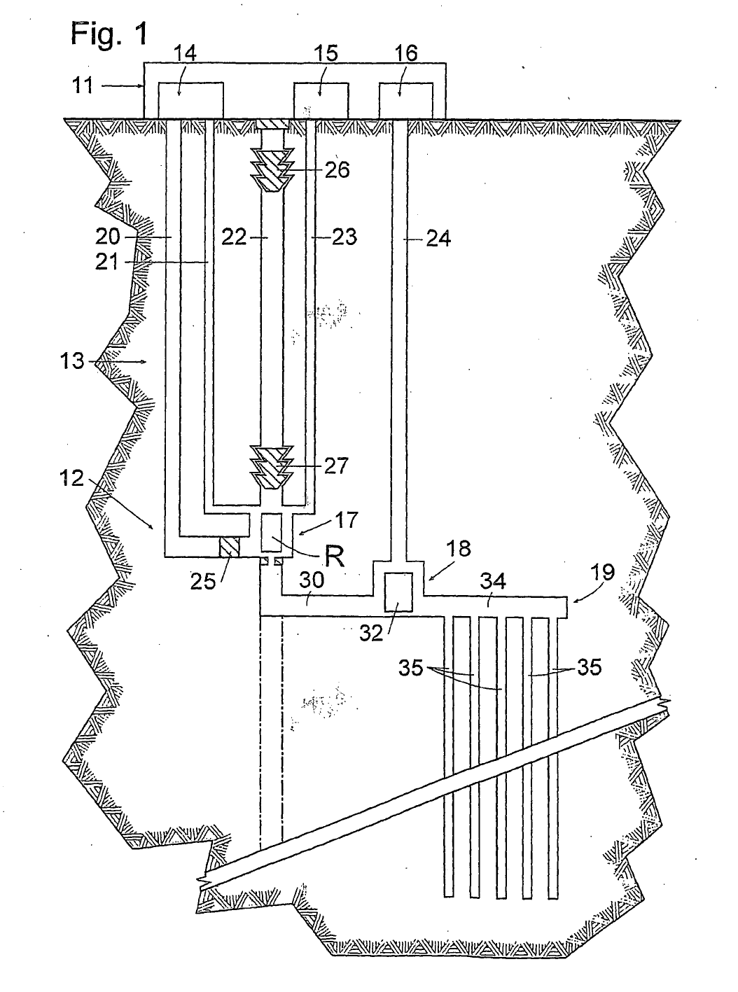

FIG. 1 is a greatly diagrammatic vertical sectional view of a nuclear power installation constructed in accordance with the invention; and

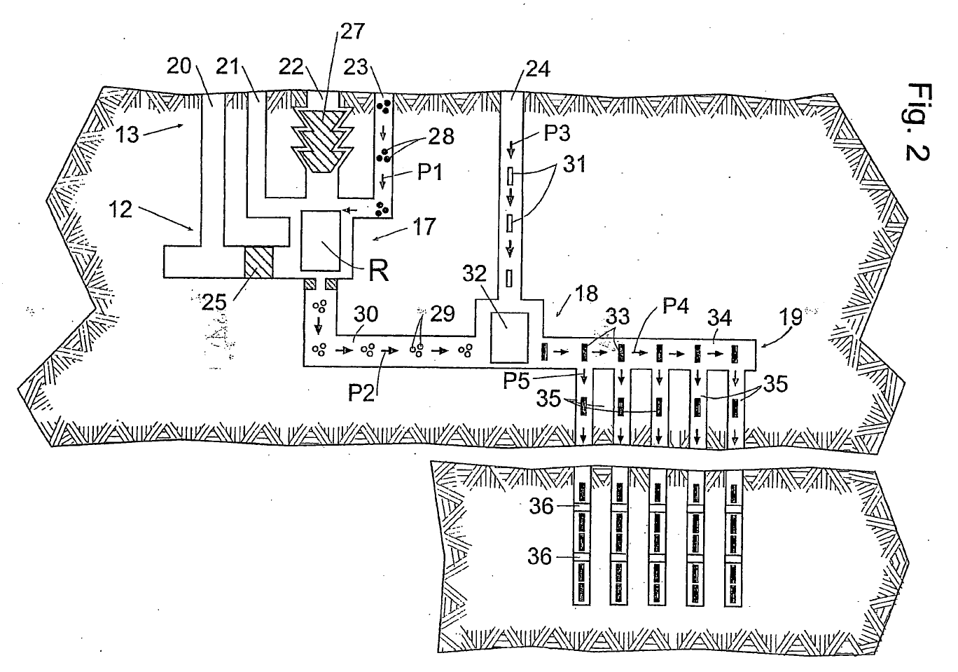

FIG. 2 is an enlarged and slightly more detailed view of the deep-level part of the installation.

The structural design of the various parts from which the installation is constructed is no essential element of the invention; it is within the scope of knowledge and ability of the person skilled in the art to put the invention into practice with the aid of this description.

As illustrated by an exemplary embodiment, the installation comprises an upper part, generally designated by reference character 11, which is located near the ground level, a lower, deep-level part, which is generally designated by reference character 12, and an intermediate part, which is generally designated by reference character 13 and separates the upper ground-level part 11 of the installation from the lower, deep-level part 12 of the installation.

The ground-level part 11 of the installation is shown located on the ground surface, but it may also be located partly or wholly below the ground surface. However, there shall be a distance from the ground-level part 11 of the installation down to the deep-level part 12 which is adequate to satisfy the safety requirements.

Main sections of the ground-level part 11 are buildings and other essential facilities for:
1. Management, conversion and distribution of the produced energy, such as heat exchangers, turbines, electrical generators and so on, and control and supervision of the installation. Naturally, some of these facilities may alternatively be placed in the deep-level part 12 of the installation.
2. Storage and management of fresh nuclear fuel;
3. Handling of devices in which spent nuclear fuel is to be contained, possibly also manufacture and assembly of such devices.

These main sections of the ground-level part of the installation are designated, in the order they are mentioned above, by 14, 15 and 16.

The deep-level part 12 of the installation comprises three main sections, namely:
1. A reactor section 17 accommodating the nuclear reactor, which is designated by R in FIGS. 1 and 2, and such additional components as are directly associated the reactor, that is, necessarily or preferably placed near the reactor, such as for handling of the nuclear fuel. The reactor section 17 may also include certain elements or components means of which the energy produced in the reactor R is made useful.
2. A fuel containment section 18, in which spent nuclear fuel is introduced into dedicated storage devices, which are supplied from section 16 of the ground-level part 11 of the installation or are partly or completely assembled within the containment section 18, and in which the storage devices loaded with the nuclear fuel are sealed.
3. A fuel storage section 19, in which the storage devices with the contained spent nuclear fuel are lowered in very deep storage shafts for long-term storage, suitably final storage.

Within the intermediate part 13, the illustrated nuclear power installation includes a plurality of shafts which extend between the upper, ground-level part 11 of the installation and the lower, deep-level part 12 of the installation. In the drawings five such shafts are shown and designated by 20, 21, 22, 23 and 24. As to the rest of the intermediate part 13, it is formed mainly of the ground (bedrock). Together, the shafts 20 to 24 form a connection or passageway through which the parts 11 and 12 of the installation communicate.

The shaft designated by 20 is here referred to as a service shaft and is intended to be used in connection with inspection, service, maintenance, repair and other instances when it is necessary for personnel to access the deep-level part 12 of the installation and, if required, bring in materials and equipment. The connection between the service shaft 20 and the deep-level part 12 of the installation is meant to be normally blocked in a safe manner but is adapted to be opened by authorised personnel when required. A blocking point with blocking elements is designated by 25.

Shaft 21, which may be divided into a plurality of subshafts, accommodates conduits and other means for transmission of energy and signals between the ground-level part 11 of the installation and the deep-level part 12.

Shaft 22 is a relatively wide shaft which is primarily intended to be used during the construction for transport of materials and equipment between the ground surface or the ground-level part 11 and the deep-level part 12. In the drawings it is shown as being permanently or semi-permanently closed at a point 26 near the ground level and at a point 27 near the reactor section 17.

Shaft 23 is used for transport of fresh nuclear fuel from the ground-level part 11 of the installation to the reactor section 17. Here, the reactor R is presumed to be a reactor of a PB type, and in FIG. 2 solid spheres symbolically represent fresh nuclear fuel 28 in the form of fuel spheres and, possibly, graphite spheres handled together with the fuel spheres. The transport of the nuclear fuel 29 and facilities used for this transport are symbolically represented by downwardly pointing arrows P1.

Shaft 24, finally, is associated with the fuel containment section 18, that is, the section of the deep-level part 12 of the installation into which spent nuclear fuel 29 is transported from the reactor section 17 through a tunnel or other connecting passageway 30. In FIG. 2, the transport of the spent nuclear fuel 29 and facilities used for this transport are symbolically represented by arrows P2. The spent nuclear fuel in the form of fuel spheres and any graphite spheres transported together with them are symbolically represented by open circles.

In the fuel containment section 18 the spent nuclear fuel is introduced into rigid and resistant, suitably cylindrical fuel containers of concrete and/or metal, for example, which are then sealed. Empty fuel containers 31, symbolically represented by open rectangles, are transported from section 16 in the ground-level part 11 of the installation through the shaft 24 into the fuel containment section 18. The transport of the empty fuel containers 31 and the facilities used for this transport are symbolically represented by arrows P3.

In a loading station 32 the fuel is introduced by means of suitable handling apparatus into the fuel containers 31 which are then sealed.

The fuel containers 31 may be made, loaded with nuclear fuel and sealed using known technologies, see, for example, WO2004/051671.

The loaded and sealed fuel containers 33, represented by solid rectangles, are then transported through a connecting cave 34, such as a tunnel, to the fuel storage section 19. This transport and the facilities used for this transport are symbolically represented by arrows P4. In the fuel storage section 19 the fuel containers 33 are placed, in a manner to be described, in a drilled storage shaft 35 which extends downwards from the connecting cave 34 to a very great depth from the ground level, suitably at least 500 metres and preferably a thousand or a few thousand metres. In the drawings, five such storage shafts 35 are shown, but it goes without saying that the number of storage shafts may be much larger.

The above-mentioned parts and components of the nuclear power installation may be more or less conventional. To the extent that they have to be adapted or arranged in any particular manner in view of the location of the reactor R and other parts and of the far-reaching remote control and remote monitoring which the location of the installation necessitates in practice, such adaptation can be accomplished by the person skilled in the art.

When the nuclear power installation is constructed, the shafts are excavated by drilling, starting from the ground surface; well established methods for drilling of very wide and deep shafts is available today. Starting from these shafts, the spaces required for the deep-level part 13 of the installation, thus the cave for the reactor section 17, the connecting passageway 30, the cave for the fuel containment section 18, the connecting cave 34 and other spaces or passageways which are required. The equipment required for this excavation can be taken down through the shaft 22, for example, which is sufficiently wide to permit taking down rather bulky equipment. Lifts or other transportation apparatus can be installed in one or more shafts to carry materials, equipment and workers.

The reactor R and other parts of the installation which are required in the deep-level part 12 of the installation can then be taken down and installed.

When the installation is complete and ready for operation, the shaft 22 can suitably be sealed at the upper and lower ends, preferably in such a manner that it will be possible to reopen the shaft if required, such as in connection with very extensive repairs, rebuilding or demolition.

When the installation is in operation, fresh nuclear fuel 28, fuel spheres in the illustrated exemplary embodiment, is continuously or quasi continuously supplied (arrows P1) to the reactor R, where it is fed into the reactor and passes through it as is known per se. Burnt-up fuel spheres 29 and any graphite spheres are withdrawn at the bottom of the reactor R and transported (arrows P2) to the fuel containment section 18. The fuel containers 33 with the contained fuel spheres are transported (arrows P4) from the fuel containment section 18 to one of the storage shafts and introduced and stacked therein. The introduction of the fuel containers 33 and the stacking is symbolically shown by arrows P5. Handling of the fuel containers 33 and relieving members yet to be described below is carried out from the connecting cave 34.

The storage shafts 35 may be relatively narrow, 50 to 70 cm in diameter, for example, and only slightly wider than the fuel containers, so that each container fills almost the entire shaft cross-section. As the stack grows in the shaft 35, relieving members 36 may be firmly anchored in the shaft wall so that the stack is subdivided into a suitable number of substacks, each substack resting on such a relieving member 36. Crushing of fuel containers under the force from overlying fuel containers is thus avoided. Before a relieving member is mounted, the empty space around the fuel containers 33 may be filled with concrete, suitably so-called self-compacting concrete, which easily finds its way downwards along the stack and completely fills the space around it.

Suitably, the shafts 35 are not filled completely but only to a level which is a safe distance lower than the connecting cave 34, 100 to 300 metres lower, for example. When that level has been reached, the free remaining part of the shaft can be filled with concrete, suitably self-compacting concrete, so that the shaft will be effectively sealed.

As is shown in the drawings, the connecting passageway 30, the loading station 32, the connecting cave 34 and the upper ends of the storage shafts 35 are at a level that is somewhat lower than the level at which the reactor section 17 is located. If desired, a deep shaft may be excavated under the reactor section 17 and used for direct dumping of nuclear fuel if a failure in the reactor R or some other section of the installation should necessitate a rapid discharge of fuel from the reactor. Such an emergency dumping shaft is indicated in broken lines in FIG. 1.

In the description above and in the drawings, the invention is exemplified by way of an embodiment that comprises a PB reactor operating with a more or less continuous introduction of fresh nuclear fuel into the reactor and discharge of burnt-up nuclear fuel from it. A different type of PB reactor that may very advantageously be used is a reactor of the type disclosed in U.S. Pat. No. 5,051,230, with which the installation can be operated basically continuously for 2 to 3 years, for example, without introduction of fresh nuclear fuel into the reactor and discharge of burnt-up fuel from it.

1. A nuclear power installation comprising
a nuclear reactor a placed in a deep-level lower part of the installation located below the ground level,
installation facilities for making energy produced in the nuclear reactor useful and for the control and monitoring of the nuclear reactor, said installation facilities being partly placed in a ground-level upper part of the installation which is connected to the lower part of the installation through a passageway extending through an intermediate part of the installation which separates the upper part of the installation from the lower part of the installation,
installation facilities for loading of fresh nuclear fuel into the nuclear reactor and for the withdrawal of spent nuclear fuel from the nuclear reactor, and
installation facilities for the transfer of spent nuclear fuel from the nuclear reactor into storage containers and for the transfer of these storage containers and spent fuel introduced into them to a storage site, wherein
at least most of said installation facilities for making energy useful and for the control and monitoring of the nuclear reactor are placed in the ground-level upper part of the installation,
the lower part of the installation comprises a cave accommodating said installation facilities for the transfer of spent nuclear fuel into storage containers and for the transfer of these storage containers and spent fuel introduced into them to the storage site, and
the storage site is situated at a level which is lower than said cave.

2. A nuclear power installation according to claim 1, wherein the storage site comprises a plurality of shafts which are positioned side by side and extend downwards, preferably at least 500 meters, from said cave.

3. A nuclear power installation according to claim 1, wherein there is provided below the nuclear reactor a shaft into which nuclear fuel discharged from the nuclear reactor can be dumped.

4. A nuclear power installation according to claim 1, wherein said passageway is at least partly blocked.

5. A nuclear power installation according to claim 1, wherein said passageway comprises a plurality of drilled shafts.

6. A nuclear power installation according to claim 1, including a separate shaft with facilities for the transport of fresh nuclear fuel to the nuclear reactor.

7. A nuclear power installation according to claim 1, including a separate shaft for the transport of empty fuel containers from the upper part of the installation to a loading station provided in the lower part of the installation for the transfer of nuclear fuel withdrawn from the nuclear reactor into the fuel containers.

8. A nuclear power installation according to claim 1, wherein said passageway comprises a shaft which is wide enough to permit transport between the upper and the lower part of the installation of the largest single component from which the nuclear reactor is constructed.

9. A method for constructing a nuclear power installation, said method comprising the following steps:
excavating a passageway from the ground level down to a level deep below the ground level and providing at the deep level a lower part of the installation, said lower part including a reactor cave for a nuclear reactor, a cave for installation facilities and a storage site for nuclear fuel withdrawn from the reactor, said storage site being situated at a level which is lower than said cave for installation facilities,
installing a nuclear reactor in the reactor cave,
placing in said cave for installation facilities a loading station for transferring nuclear fuel withdrawn from the nuclear reactor into fuel containers and for transferring these fuel containers and nuclear fuel transferred into them to the storage site, and
providing a ground level upper part of the installation and providing it with equipment for making energy produced in the nuclear reactor useful, equipment for the control and monitoring of the nuclear reactor, and equipment for the transfer of fresh nuclear fuel to the nuclear reactor, said equipment communicating with said equipment in the lower part of the installation through said passageway, which extends through an intermediate part of the installation situated between the upper and lower parts of the installation.

10. A method according to claim 9, wherein the passageway is excavated by drilling a plurality of shafts positioned side by side.
